(19) United States
(12) Patent Application Publication
(10) Pub. No.: US 2003/0138605 A1
(43) Pub. Date: Jul. 24, 2003

(54) Small porous polyester particles for inkjet use

(75) Inventors: Christine J. Landry-Coltrain, Fairport, NY (US); Jeffrey W. Leon, Rochester, NY (US); Linda M. Franklin, Rochester, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/028,130

(22) Filed: Dec. 20, 2001

(51) Int. Cl. B32B 3/00

(52) U.S. Cl. 428/195

(57) ABSTRACT

The present invention comprises porous polyester particles comprising porous polyester particles having a mean diameter of less than 0.5 micrometers. The present invention further comprises an inkjet recording element comprising a support having thereon at least one ink receiving layer capable of accepting an inkjet image, said layer(s) comprising porous polyester particles comprising porous polyester particles having a mean diameter of less than 0.5 micrometers. The present invention also includes a method of forming an inkjet print comprising providing an inkjet recording element comprising porous polyester particles comprising porous polyester particles having a mean diameter of less than 0.5 micrometers and printing on said inkjet recording element utilizing an inkjet printer.

### CROSS REFERENCE TO RELATED APPLICATIONS

Reference is made to commonly assigned, co-pending U.S. patent applications:

Ser. No. ______ by Leon et al., (Docket 82842) filed of even date herewith entitled “Method of Preparation of Porous Polyester Particles”;

Ser. No. ______ by Landry-Coltrain et al., (Docket 83466) filed of even date herewith entitled “Multilayer Inkjet Recording Element with Porous Polyester Particles”.

### FIELD OF THE INVENTION

This invention relates to porous polyester particles. The invention further relates to an inkjet recording element, more particularly to an inkjet recording element containing porous polyester particles.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol or mixtures thereof.

An inkjet recording element typically comprises a support having on at least one surface thereof an ink-receiving or image-forming layer and includes those intended for reflection viewing, which have an opaque support, and those intended for viewing by transmitted light, which have a transparent support.

An inkjet recording element that simultaneously provides an almost instantaneous ink dry time and good image quality is desirable. However, given the wide range of ink compositions and ink volumes that a recording element needs to accommodate, these requirements of inkjet recording media are difficult to achieve simultaneously.

Inkjet recording elements are known that employ porous or non-porous single layer or multilayer coatings that act as suitable ink receiving layers on one or both sides of a porous or non-porous support. Recording elements that use non-porous coatings typically have good image quality and stability but exhibit poor ink dry time. Recording elements that use porous coatings typically contain colloidal particulates and have poorer image stability but exhibit superior dry times.

While a wide variety of different types of porous image recording elements for use with inkjet printing are known, there are many unsolved problems in the art and many deficiencies in the known products which have severely limited their commercial usefulness. A major challenge in the design of a porous image-recording layer is to be able to obtain good quality, crack-free coatings. Inkjet prints, prepared by printing onto inkjet recording elements, are subject to environmental degradation. They are especially vulnerable to light fade and fade resulting from gaseous impurities in the air, such as ozone and nitrous oxide. Highly swellable hydrophilic layers can take an undesirably long time to dry, slowing printing speed. Porous layers speed the absorption of the ink vehicle, but often suffer from insufficient gloss and severe dye fade. Porous layers are also difficult to coat without cracking.

Japanese Kokai 07-137432 describes an inkjet paper having an ink-absorbing layer containing polyester resin particles with internal pores. However, there is a problem with this element in that the average particle size of the polyester resin is greater than 0.5 microns, and the element will have low surface gloss.

It is an object of this invention to provide an inkjet recording element which will provide improved ink uptake speed. Another objective of the invention is to provide an inkjet recording element having high surface gloss. Another objective of the invention is to provide an inkjet recording element having a receiving layer that when printed upon has an excellent image quality and stability.

### SUMMARY OF THE INVENTION

The present invention comprises porous polyester particles comprising porous polyester particles having a mean diameter of less than 0.5 micrometers. The present invention further comprises an inkjet recording element comprising a support having thereon at least one ink receiving layer capable of accepting an inkjet image, said layer(s) comprising porous polyester particles comprising porous polyester particles having a mean diameter of less than 0.5 micrometers. The present invention also includes a method of forming an inkjet print comprising providing an inkjet recording element comprising porous polyester particles comprising porous polyester particles having a mean diameter of less than 0.5 micrometers and printing on said inkjet recording element utilizing an inkjet printer.

Using the invention, a recording element is obtained which will provide improved ink uptake speed, high surface gloss and, when printed upon, has an excellent image quality.

### DETAILED DESCRIPTION OF THE INVENTION

The porous polyester particles useful for this invention are described in Ser. No. ______ by Leon et al., (Docket 82842) filed of even date herewith entitled “Method of Preparation of Porous Polyester Particles”. The crosslinked, porous polyester particles are prepared by crosslinking an unsaturated precursor polyester within an oil-in-water emulsion in the presence of a water-immiscible organic solvent. A precursor polyester is a polyester containing unsaturated groups which is used in turn to make porous polyester particles. The crosslinking reaction is a radical-initiated polymerization of an ethylenically unsaturated monomer which readily copolymerizes with the unsaturated units in the precursor polyester. The precursor polyester can be organic-soluble, in which case an added emulsifying agent is necessary. In another embodiment of this method, the precursor polyester can be water-soluble, water-dispersible, or amphiphilic in character, in which case the precursor polyester acts as the emulsifying species and an added emulsifying agent is merely optional. The water-immiscible organic solvent is removed to yield a dispersion of porous, crosslinked, polyester-containing particles.

The precursor polyesters which may be used to form the porous polyester particles useful for this invention are branched or unbranched, contain chemical unsaturation, and are soluble either in water-immiscible organic solvents or in water. Optionally, the precursor polyester may be self-emulsifying in water or amphiphilic or surfactant-like in character. The precursor polyesters may have any glass transition temperature, provided it fulfills the solubility requirements. Preferably, the number average molecular weight (Mn) is between 1,000 and 30,000 gm/mole.

As is well known in the art, polyesters are condensation products of polybasic acids or of corresponding acid equivalent derivatives such as esters, anhydrides or acid chlorides and polyhydric alcohols. It will be known that whenever “diacids” or “polyacids” are referred to in this document, that corresponding acid equivalent derivatives such as esters, anhydrides or acid chlorides are also included by reference. Polymerizable unsaturation may be introduced into the molecule by the selection of a polybasic acid or polyhydric alcohol, which contains α, β-ethylenic unsaturation. In most cases, the unsaturation will be contained within the polybasic acid unit. Optionally, one or more additional polyacids common in the art of polycondensation may be used in addition to the unsaturated polyacid. These ethylenically unsaturated polyacids include, but are not necessarily limited to maleic, fumaric, itaconic, phenylenediacrylic, citraconic and mesaconic acid. Other, additional polyacids which do not contain chemical unsaturation and can be used in polyesters are described in WO 01/00703 and are incorporated herein by reference. These diacids can include, but are not necessarily limited to malonic, succinic, glutaric, adipic, pimelic, azelaic, and sebacic acids, phthalic, isophthalic, terephthalic, tetrachlorophthalic, tetrahydrophthalic, trimellitic, trimesic, isomers of naphthalenedicarboxylic acid, chlorendic acid, trimellitic acid, trimesic acid, and pyromellitic acid.

Ethylenically unsaturated groups can also be introduced into the precursor polyester by synthetic modification. For example, a polyester with a high alcohol number can be reacted with an anhydride or acid chloride of acrylic acid or methacrylic acid in order to introduce ethylenically unsaturated units.

Precursor polyesters that are suitable for this invention can furthermore be comprised of any of a wide variety of polyhydric alcohols which are well known in the art of polycondensation and may be aliphatic, alicyclic, or aralkyl. A description of suitable polyhydric alcohols is given in WO 01/00703 and are incorporated herein by reference. These alcohols can include, but are not necessarily limited to ethylene glycol, 1,3-propylene glycol, 1,6-hexanediol, 1,10-decanediol, 1,4-cyclohexanedimethanol, 1,4-cyclohexanediol, hydroquinone bis (hydroxyethyl) ether, diethylene glycol, neopentyl glycol, bisphenols such as bisphenol A, ethylene oxide and propylene oxide adducts of bisphenol A, pentaerythritol, trimethylolpropane, and polyester polyols, such as that obtained by the ring-opening polymerization of ε-caprolactone. Additionally, A-B type polycondensation monomers which contain both hydroxyl and acid derivative functions can be used as well as monoacids and monoalcohols.

In one embodiment of this invention, precursor polyesters which are water-soluble, surfactant-like, or self-emulsifying and additionally contain chemical unsaturation may be utilized. Water-soluble, surfactant-like, and self-emulsifying polyesters are well known in the art and will contain one or more type of hydrophilic chemical group, functionality, or monomer, such as carboxylate, quaternary ammonium, sulfonate, sulfate, sulfonium, phosphonium, iminosulfonyl, or polymeric or oligomeric oxyethylene segments. Precursor polyesters used to form the porous polyester particles useful in this invention will additionally contain one or more polyacid or polyol monomers which contain ethylenic unsaturation as detailed above. The water-soluble, surfactant-like, and self-emulsifying precursor polyesters used to form the porous polyester particles useful in this invention may contain one or more diacid or diol components which can induce hydrophilic character or water-solubility. The most common hydrophilic diol used for this purpose is polyethylene glycol. Additionally, tertiary amine units substituted with two or three hydroxyalkyl groups can be incorporated within a precursor polyester and rendered ionic either by quaternization with an alkylating agent or by neutralization with an acid. A commonly used class of diacid components used to impart hydrophilicity to polyesters includes compounds containing sulfonate or sulfonimide salts. Some suitable sulfonated diacids are described in U.S. Pat. Nos. 4,973,656 and 5,218,042 and are incorporated herein by reference. Examples of such diacids are 5-sodiosulfoisophthalic acid, 2-sodiosulfobutanoic acid, and di-Me sodioiminobis(sulfonyl-m-benzoate). Another common strategy for the hydrophilization of polyesters involves the neutralization of the acid end groups of polyester with a relatively high acid number. Preferably, the acid number is at least 10. Most preferably the acid number is greater than 25. The neutralization agent is usually an alkali metal hydroxide or an amine. Polyesters containing ethylenic unsaturation and neutralized acid end groups can also be used in this invention. In the preferred case, the unsaturated precursor polyester will contain an ionic group equivalent weight of between 400 and 2000 grams of polymer per mole of ionic unit.

The ethylenically unsaturated monomers useful for crosslinking the precursor polyesters in this invention are monomers commonly used in the art of addition polymerization. These include, but are not necessarily limited to methacrylic acid esters, such as methyl methacrylate, ethyl methacrylate, isobutyl methacrylate, 2-ethylhexyl methacrylate, benzyl methacrylate, phenoxyethyl methacrylate, cyclohexyl methacrylate and glycidyl methacrylate, acrylate esters such as methyl acrylate, ethyl acrylate, isobutyl acrylate, 2-ethylhexyl acrylate, benzyl methacrylate, phenoxyethyl acrylate, cyclohexyl acrylate, and glycidyl acrylate, styrenics such as styrene, α-methylstyrene, 3- and 4-chloromethylstyrene, halogen-substituted styrenes, and alkyl-substituted styrenes, vinyl halides and vinylidene halides, N-alkylated acrylamides and methacrylamides, vinyl esters such as vinyl acetate and vinyl benzoate, vinyl ethers, such as butyl vinyl ether and cycloxexanedimethanol divinyl ether, allyl alcohol and its ethers and esters, and unsaturated ketones and aldehydes such as acrolein and methyl vinyl ketone and acrylonitrile.

In addition, small amounts (typically less than 10% of the total weight of the polymerizeable solids) of one or more water-soluble ethylenically unsaturated monomer can be used. Such monomers include but are not necessarily limited to styrenics, acrylates, and methacrylates substituted with highly polar groups, unsaturated carbon and hetero atom acids such as acrylic acid, methacrylic acid, fumaric acid, maleic acid, itaconic acid, vinylsulfonic acid, vinylphosphonic acid, and their salts, vinylcarbazole, vinylimidazole, vinylpyrrolidone, and vinylpyridines.

Especially useful in this invention are monomers containing more than one ethylenically unsaturated unit, such as trimethylolpropane triacrylate, ethylene glycol dimethacrylate, isomers of divinylbenzene, divinyl adipate, cyclohexanedimethanol divinyl ether and ethylene glycol divinyl ether.

Ethylenically unsaturated monomers which are preferred for this invention are styrenics, vinyl ethers, and methacrylates. Divinylbenzene (m, and p isomers), styrene, divinyl adipate, and ethylene glycol dimethacrylate are especially preferred.

Any of the common water-soluble or organic-soluble free radical polymerization initiators known in the art of addition polymerization can be used for this invention. These include, but are not restricted to azo compounds, such as 2,2′-azobis(4-methoxy-2,4-dimethylvaleronitrile), (1-pheneylethyl)azodiphenylmethane, 2-2′-azoisobutyronitrile (AIBN), 1,1′-azobis(1-cyclohexanedicarbonitrile), 4,4′-azobis(4-cyanopentanoic acid), and 2,2′-azobis(2-amidinopropane) dihydrochloride, organic peroxides, organic hydroperoxides, peresters, and peracids such as benzoyl peroxide, lauryl peroxide, capryl peroxide, acetyl peroxide, t-butyl hydroperoxide, t-butyl perbenzoate, cumyl hydroperoxide, peracetic acid, 2,5-dimethyl-2,5-di(peroxybenzoate), and p-chlorobenzoly peroxide, persulfate salts such as potassium, sodium and ammonium persulfate, disulfides, tetrazenes, and redox initiator systems such as H₂O₂/Fe²⁺, persulfate/bisulfite, oxalic acid/Mn³⁺, thiourea/Fe³⁺, and benzoyl perozide/dimethylaniline.

Optionally, a small amount of a cosurfactant stabilizer, typically comprising 1-10% by weight of the organic phase, may be added to the organic phase of this invention. These hydrophobic compounds are known to prevent Ostwald ripening in certain types of emulsion and suspension polymerization. Excellent discussions of cosurfactants are given in Emulsion Polymerization and Emulsion Polymers by Peter A Lovell and Mohammed S. El-Aaser, (John Wiley and Sons: Chichester, 1997; pp. 700-721) and U.S. Pat. No. 5,858,634. The most common cosurfactants are hexadecane and hexadecanol. Other useful cosurfactants may also serve other roles, such as acting as monomers or initiators. An example of the former is lauryl methacrylate. An example of the latter is lauroyl peroxide.

If a precursor polyester is used in this invention which is not soluble or dispersible in water, then an emulsifier must additionally be used, although an emulsifier can be used in tandem with a water-soluble or water-dispersible precursor polyester. It is preferable that the emulsifier be present in the aqueous phase. Though a very large variety of emulsifiers are known in the art, most of these fit into the three basic categories of surfactants, colloidal inorganics, and protective colloids. There exist a tremendous number of known surfactants. Good reference sources for surfactants are the Surfactant Handbook (GPO: Washington, D.C., 1971) and McCutcheon's Emulsifiers and Detergents (Manufacturing Confectioner Publishing Company: Glen Rock, 1992). There are no general restrictions for the surfactants which are useful in this invention. Useful surfactants can be anionic, cationic, zwitterionic, neutral, low molecular weight, macromolecular, synthetic, or extracted or derived from natural sources. Some examples include, but are not necessarily limited to: sodium dodecylsulfate, sodium dodecylbenzenesulfonate, sulfosuccinate esters, such as those sold under the AEROSOL® trade name, flourosurfactants, such as those sold under the ZONYL® and FLUORAD® trade names, ethoxylated alkylphenols, such as TRITON® X-100 and TRITON® X-705, ethoxylated alkylphenol sulfates, such as RHODAPEX® CO-436, phosphate ester surfactants such as GAFAC® RE-90, hexadecyltrimethylammonium bromide, polyoxyethylenated long-chain amines and their quaternized derivatives, ethoxylated silicones, alkanolamine condensates, polyethylene oxide-co-polypropylene oxide block copolymers, such as those sold under the PLURONIC® and TECTRONIC® trade names, N-alkylbetaines, N-alkyl amine oxides, and fluorocarbon-poly(ethylene oxide) block surfactants, such as FLUORAD® FC-430.

Protective colloids useful in this invention include, but are not necessarily limited to: poly (ethylene oxide), hydroxyethyl cellulose, poly (vinyl alcohol), poly (vinyl pyrrolidone), polyacrylamides, polymethacrylamides, sulfonated polystyrenes, alginates, carboxy methyl cellulose, polymers and copolymers of dimethylaminoethylmethacrylate, water soluble complex resinous amine condensation products of ethylene oxide, urea and formaldehyde, polyethyleneimine, casein, gelatin, albumin, gluten and xanthan gum. Protective colloids are a class of emulsifiers which are used in lieu of or in addition to a surfactant. They are typically dissolved or dispersed in the aqueous phase prior to the emulsification step.

Similarly, colloidal inorganic particles can be employed as emulsifiers as part of a limited coalescence process. Colloidal inorganic particles can be employed in lieu of or in addition to any other type of emulsifier listed, such as a surfactant or protective colloid. They are also added to the aqueous phase. Limited coalescence techniques have been describe in numerous patents such as U.S. Pat. Nos. 4,833,060 and 4,965,131. A colloidal inorganic which is particularly useful in this invention is LUDOX® TM sold by Du Pont.

Additional additives which can be incorporated into the porous polyester particles useful in this invention include pigments, dyes, biocides, fungicides, electrolytes, buffers, UV-absorbers, antioxidants and chain transfer agents.

The porous polyester particles useful for this invention comprise porous polyester particles having a mean diameter of less than 0.5 micrometers. For optimal ink absorption properties and coating quality, it is preferable that the porous polyester particles have a mean diameter range between 0.1 and less than 0.5 micrometers, and more preferably, that the porous polyester particles have a mean diameter range between 0.2 and 0.3 micrometers. The diameter of the particles can be measured by any method known in the art. One such method is laser light scattering of dilute dispersions of the particles, using a commercially available instrument such as the Horiba LA-920, manufactured by Horiba LTD. Typically, a sample of porous polyester particles will contain a population of particles having a distribution of sizes. This is the particle size distribution, and is characterized by a mean diameter, a standard deviation, and a coefficient of variation. The mathematical equations defining these terms can be found in any basic text on statistical analysis, such as “Principles of Instrumental Analysis, 4^{th} Edition”, by D. A. Skoog and J. J. Leary, Harcourt Brace College Publishers, Orlando, Fla., 1971 (Appendix A-6). The mean diameter is the arithmetic mean of the particle size distribution. The coefficient of variation (CV) of a distribution is the ratio of the standard deviation of the distribution to the mean diameter, given as a percent. The porous polyester particles useful for this invention can have a relatively large distribution of particle sizes within one mode, and the standard deviation in the mean diameter can be between about 0.3 times the mean particle diameter and 3 times the mean particle diameter. In a system of particles, there can be a single mode or peak to this distribution of sizes, or there can be several modes, each mode being characterized by a mean diameter, a standard deviation, and a coefficient of variation. For example, the porous polyester particles can be a system composed of particles having a mode with a mean diameter of less than 0.5 micrometers and particles having a mode with mean diameter greater than 0.5 micrometers, preferably having a mean diameter between 1 and 10 micrometers, and most preferably having a mean diameter between 1 and 3 micrometers. The relative proportions of these two modes are calculated from the relative areas under the curves representing the modes, and should add up to 100%.

In the preferred case, the porous polyester particles will contain an ionic group equivalent weight of between 40 and 2000 grams per mole of ionic unit. The product particles, having excellent colloidal stability, can be stored as an aqueous dispersion or freeze dried to yield a solid powder comprising dry particles which will easily redisperse in water.

The ink receiving layer of the inkjet element is formed by coating a mixture comprised of these porous polyester particles and a binder in an amount insufficient to alter the porosity of the porous receiving layer onto a support, and then drying to remove approximately all of the volatile components. In a preferred embodiment, the polymeric binder is a hydrophilic polymer such as polyvinylpyrrolidone and vinylpyrrolidone-containing copolymers, polyethyloxazoline and oxazoline-containing copolymers, imidazole-containing polymers, polyacrylamides and acrylamide-containing copolymers, poly(vinyl alcohol) and vinyl-alcohol-containing copolymers, poly(vinyl methyl ether), poly(vinyl ethyl ether), poly(alkylene oxides), gelatin, cellulose ethers, poly(vinylacetamides), partially hydrolyzed poly(vinyl acetate/vinyl alcohol), poly(acrylic acid), sulfonated or phosphated polyesters and polystyrenes, casein, albumin, chitin, chitosan, dextran, pectin, collagen derivatives, collodian, agar-agar, arrowroot, guar, carrageenan, tragacanth, xanthan, rhamsan and the like. In another preferred embodiment of the invention, the hydrophilic polymer is hydroxyethyl cellulose, hydroxypropyl cellulose, hydroxypropyl methyl cellulose, methyl cellulose, or a poly(alkylene oxide). In still another preferred embodiment, the polymeric binder is a latex such as poly(styrene-co-butadiene), polyurethane, polyester, poly(acrylate), poly(methacrylate), a copolymer of n-butylacrylate and ethylacrylate, and a copolymer of vinylacetate and n-butylacrylate. In still another preferred embodiment, the polymeric binder is a water dispersible condensation polymer such as a polyurethane. In still another preferred embodiment, the binder is a condensate of alkoxysilanes or other metal sols such as alumina sol, titania sol, or zirconia sol. Mixtures of the above listed hydrophilic polymers can be used. The binder should be chosen so that it is compatible with the aforementioned particles.

The amount of polymer binder used should be sufficient to impart cohesive strength to the inkjet recording element, but should also be minimized so that the interconnected pore structure formed by the aggregates is not filled in by the binder. In a preferred embodiment of the invention, the porous polyester particles are present in an amount of between 50 and 95% by weight, and most preferably, in an amount between 75 and 90% by weight of the layer.

Since the image recording element may come in contact with other image recording articles or the drive or transport mechanisms of image recording devices, additives such as filler particles, surfactants, lubricants, crosslinking agents, matte particles and the like may be added to the element to the extent that they do not degrade the properties of interest.

Filler particles may be used in the ink receiving layer such as silicon oxide, fumed silica, silicon oxide dispersions such as those available from Nissan Chemical Industries and DuPont Corp., aluminum oxide, fumed alumina, calcium carbonate, barium sulfate, barium sulfate mixtures with zinc sulfide, inorganic powders such as γ-aluminum oxide, chromium oxide, iron oxide, tin oxide, doped tin oxide, alumino-silicate, titanium dioxide, silicon carbide, titanium carbide, and diamond in fine powder, as described in U.S. Pat. No. 5,432,050.

A dispersing agent, or wetting agent can be present to facilitate the dispersion of the filler particles. This helps to minimize the agglomeration of the particles. Useful dispersing agents include, but are not limited to, fatty acid amines and commercially available wetting agents such as Solsperse® sold by Zeneca, Inc. (ICI). Preferred filler particles are silicon oxide, aluminum oxide, calcium carbonate, and barium sulfate. Preferably, these filler particles have a median diameter less than 1.0 μm. The filler particles can be present in the amount from about 0 to 80 percent of the total solids in the dried ink receiving layer, most preferably in the amount from about 0 to 40 percent.

The inkjet element may include lubricating agents. Lubricants and waxes useful either in the ink receiving layer or on the side of the element that is opposite the ink receiving layer include, but are not limited to, polyethylenes, silicone waxes, natural waxes such as carnauba, polytetrafluoroethylene, fluorinated ethylene propylene, silicone oils such as polydimethylsiloxane, fluorinated silicones, functionalized silicones, stearates, polyvinylstearate, fatty acid salts, and perfluoroethers. Aqueous or non-aqueous dispersions of submicron size wax particles such as those offered commercially as dispersions of polyolefins, polypropylene, polyethylene, high density polyethylene, microcrystalline wax, paraffin, natural waxes such as carnauba wax, and synthetic waxes from such companies as, but not limited to, Chemical Corporation of America (Chemcor), Inc., Michelman Inc., Shamrock Technologies Inc., and Daniel Products Company, are useful.

In order to obtain adequate coatability, additives known to those familiar with such art such as surfactants, defoamers, alcohol and the like may be used. Coating aids and surfactants include, but are not limited to, nonionic fluorinated alkyl esters such as FC-430®, FC-431®, FC-10®, FC-171® sold by Minnesota Mining and Manufacturing Co., Zonyl® fluorochemicals such as Zonyl-FSN®, Zonyl-FTS®, Zonyl-TBS®, Zonyl-BA® sold by DuPont Corp., other fluorinated polymer or copolymers such as Modiper F600® sold by NOF Corporation, polysiloxanes such as Dow Coming D.C. 1248®, DC200®, DC510®, DC 190® and BYK 320®, BYK 322®, sold by BYK Chemie and SF 1079®, SF1023®, SF 1054®, and SF 1080® sold by General Electric, and the Silwet® polymers sold by Union Carbide, polyoxyethylene-lauryl ether surfactants, sorbitan laurate, palmitate and stearates such as Span® surfactants sold by Aldrich, poly(oxyethylene-co-oxypropylene) surfactants such as the Pluronic® family sold by BASF, and other polyoxyethylene-containing surfactants such as the Triton X® family sold by Union Carbide, ionic surfactants, such as the Alkanol® series sold by DuPont Corp., and the Dowfax® family sold by Dow Chemical. Specific examples are described in MCCUTCHEON's Volume 1: Emulsifiers and Detergents, 1995, North American Edition.

The ink receiving layer may include crosslinking agents. Any crosslinking agent may be used provided its reactive functionalities have the appropriate reactivity with specific chemical units in the binder. Some common crosslinkers which can crosslink binders rich in lewis basic functionalities include, but are not necessarily limited to: carbodiimides, polyvalent metal cations, organic isocyanates such as tetramethylene diisocyanate, hexamethylene diisocyanate, diisocyanato dimethylcyclohexane, dicyclohexylmethane diisocyanate, isophorone diisocyanate, dimethylbenzene diisocyanate, methylcyclohexylene diisocyanate, lysine diisocyanate, tolylene diisocyanate, diphenylmethane diisocyanate, aziridines such as taught in U.S. Pat. No. 4,225,665, ethyleneimines such as Xama-7® sold by EIT Industries, blocked isocyanates such as CA BI-12 sold by Cytec Industries, melamines such as methoxymethylmelamine as taught in U.S. Pat. No. 5,198,499, alkoxysilane coupling agents including those with epoxy, amine, hydroxyl, isocyanate, or vinyl functionality, Cymel® crosslinking agents such as Cymel 300®, Cymel 303®, Cymel 1170®, Cymel 1171® sold by Cytec Industries, and bis-epoxides such as the Epon® family sold by Shell. Other crosslinking agents include compounds such as aryloylureas, aldehydes, dialdehydes and blocked dialdehydes, chlorotriazines, carbamoyl pyridiniums, pyridinium ethers, formamidinium ethers, vinyl sulfones, boric acid, dihydroxydioxane, and polyfunctional aziridines such as CX-100 (manufactured by Zeneca Resins). Such crosslinking agents can be low molecular weight compounds or polymers, as discussed in U.S. Pat. No. 4,161,407 and references cited.

To improve colorant fade, UV absorbers, radical quenchers or antioxidants may also be added to the ink-receiving layer as is well known in the art. Examples include polyalkylenepolyamine-dicyanodiamide based polycondensation products, water soluble reducing agents, such as sulfites, nitrites, phosphates, thiosulfates, ascorbic acid or salts thereof, hydroxylamine derivatives, and glucose, sulfur-containing compounds, such as thiocyanates, thiourea, 2-mercaptobenzimidazole, 2-mercaptobenzthiazole, 2-mercaptobenzoxazole, 5-mercapto-1-methyl-tetrazole, 2,5-dimercapto-1,3,4-triazole, 2,4,6-trimercaptocyanuric acid, thiosalicylic acid, thiouracil, 1,2-bis(2-hydroxyethylthio)ethane, or hydrophobic antioxidant emulsified dispersions, such as hindered phenol based antioxidants, piperidine based antioxidants or hindered amines. UV absorbers include those described in Japanese Patent Publication Open to Public Inspection Nos. 57-74193, 57-87988, and 2-261476, antifading agents include those described in Japanese Patent Publication Open to Public Inspection Nos. 57-74192, 57-87989, 60-72785, 61-146591, 1-95091, and 3-13376.

The ink receiving layer may include pH modifiers, adhesion promoters, rheology modifiers, latexes, biocides, dyes, optical brighteners, whitening agents, described in Japanese Patent Publication Open to Public Inspection Nos. 59-42993, 59-52689, 62-280069, 61-242871, and 4-219266, and antistatic agents.

The ink receiving layer of the invention can contain one or more mordanting species or polymers. The mordant polymer can be a soluble polymer, a charged molecule, or a crosslinked dispersed microparticle. The mordant can be non-ionic, cationic or anionic. Examples of a mordant are polymers or copolymers containing a quaternized nitrogen moiety, such as, for example, poly(styrene-co-1-vinylimidazole-co-1-vinyl-3-benzylimidazolium chloride), poly(styrene-co-1-vinylimidazole-co-1-vinyl-3-hydroxyethyl-imidazolium chloride), poly(styrene-co-1-vinylimidazole-co-1-vinyl-3-benzylimidazolium chloride-co-1-vinyl-3-hydroxyethylimidazolium chloride), poly(vinylbenzyltrimethylammonium chloride-co-divinylbenzene), poly(ethyl acrylate-co-1-vinylimidazole-co-1-vinyl-3-benzylimidazolium chloride), or poly(styrene-co-4-vinylpyridine-co-4-hydroxyethyl-1-vinylpyridinium chloride). In a preferred embodiment of the invention, the quaternary nitrogen moiety incorporated in the polymer is a salt of trimethylvinylbenzylammonium, benzyldimethylvinylbenzylammonium, dimethyloctadecylvinylbenzylammonium, glycidyltrimethylammonium, 1-vinyl-3-benzylimidazolium, 1-vinyl-3-hydroxyethylimidazolium or 4-hydroxyethyl-1-vinylpyridinium. Preferred counter ions which can be used include chlorides or other counter ions as disclosed in U.S. Pat. Nos. 5,223,338, 5,354,813, and 5,403,955, the disclosures of which are hereby incorporated by reference. Other mordants suitable for the invention are cationic modified products of polymers such as poly(vinyl alcohol), gelatin, chitosan, polyvinylamine, polyethylene-imine, polydimethyldiallyl ammonium chloride, polyalkylene-polyamine dicyandiamide ammonium condensate, polyvinylpyridinium halide, polymers of (meth)acryloyl oxyalkyl quaternary ammonium salt, polymers of (meth)acrylamide alkyl quaternary ammonium salt, ω-chloro-poly(oxyethylene-polymethylene quaternary ammonium alkylate), methyl glycol chitosan, poly(vinylpyridine), propylene oxide based triamines of the Jeffamine T series, made by Texaco, Inc., quaternary acrylic copolymer latexes, phosphonium compounds, sulfonimides, sulfonated polymers and dispersed particles, and alumina hydrate. Other mordants suitable for the invention are polymers, copolymers, or latexes containing carboxylic acid, sulfonic acid, sulfonamide, sulfonimide, or phosphonic acid, such as carboxylated and sulfonated acrylates or methacrylates, carboxylated styrene butadienes, sulfonated nylons, polyesters and polyurethanes, and their salts. In a preferred embodiment of this invention, the mordanting unit may be chemically incorporated within the chemical structure of the polyester bead. For example, a sulfonated monomer within the porous polyester structure may serve as a mordant for cationic dye species.

The ink receiving element may contain multiple individual ink receiving layers. Each being comprised of a different composition, combinations of porous polyester particles with differing mean diameters, and layer thickness. For these multilayer structures, the terms as used herein, “top”, “upper”, and “above” mean the layer that is farther from the support in relation to the relative positioning with respect to the other layers. The terms “bottom” “lower” and “below” mean the layer that is closer to the support in relation to the relative positioning with respect to the other layers.

The total thickness of the ink receiving layer(s) may range from about 5 to about 100 μm, preferably from about 10 to about 50 μm. The coating thickness required is determined through the need for the coating to act as a sump for absorption of ink solvent and the need to hold the ink near the coating surface. In a multilayer structure, the ink receiving layer containing porous particles having a mean diameter of less than 0.5 micrometers has a preferred thickness of between 1 and 20 micrometers. The inkjet recording element containing porous polyester particles having a mean diameter of greater than 0.5 micrometers has a preferred thickness of between 5 and 50 micrometers. The ink receiving layers have a preferred combined thickness of between 6 and 65 micrometers.

In addition to the ink receiving layer, the recording element may also contain a base layer, next to the support, the function of which is to absorb the solvent from the ink. Materials useful for this layer include inorganic particles and polymeric binder, or highly swellable polymers such as gelatin.

The support for the inkjet recording element used in the invention can be any of those usually used for inkjet receivers. The support can be either transparent or opaque. Opaque supports include plain paper, coated paper, resin-coated paper such as polyolefin-coated paper, synthetic paper, photographic paper support, melt-extrusion-coated paper, and polyolefin-laminated paper, such as biaxially oriented support laminates. Biaxially oriented support laminates are described in U.S. Pat. Nos. 5,853,965, 5,866,282, 5,874,205, 5,888,643, 5,888,681, 5,888,683, and 5,888,714, the disclosures of which are hereby incorporated by reference. These biaxially oriented supports include a paper base and a biaxially oriented polyolefin sheet, typically polypropylene, laminated to one or both sides of the paper base. The support can also consist of microporous materials such as polyethylene polymer-containing material sold by PPG Industries, Inc., Pittsburgh, Pa. under the trade name of Teslin®, Tyvek® synthetic paper (DuPont Corp.), impregnated paper such as Duraform®, and OPPalyte® films (Mobil Chemical Co.) and other composite films listed in U.S. Pat. No. 5,244,861. Transparent supports include glass, cellulose derivatives, such as a cellulose ester, cellulose triacetate, cellulose diacetate, cellulose acetate propionate, cellulose acetate butyrate, polyesters, such as poly(ethylene terephthalate), poly(ethylene naphthalate), poly-1,4-cyclohexanedimethylene terephthalate, poly(butylene terephthalate), and copolymers thereof, polyimides, polyamides, polycarbonates, polystyrene, polyolefins, such as polyethylene or polypropylene, polysulfones, polyacrylates, polyether imides, and mixtures thereof. The papers listed above include a broad range of papers, from high end papers, such as photographic paper to low end papers, such as newsprint. In a preferred embodiment, Ektacolor paper made by Eastman Kodak Co. is employed. The term as used herein, “transparent” means the ability to pass radiation without significant deviation or absorption.

The support used in the invention may have a thickness of from about 50 to about 500 μm, preferably from about 75 to 300 μm. Antioxidants, brightening agents, antistatic agents, plasticizers and other known additives may be incorporated into the support, if desired.

In order to improve the adhesion of the ink receiving layer to the support, an under-coating or subbing layer may be applied to the surface of the support. This layer may be an adhesive layer such as, for example, halogenated phenols, partially hydrolyzed vinyl chloride-co-vinyl acetate polymer, vinylidene chloride-methyl acrylate-itaconic acid terpolymer, a vinylidene chloride-acrylonitrile-acrylic acid terpolymer, or a glycidyl (meth)acrylate polymer or copolymer. Other chemical adhesives, such as polymers, copolymers, reactive polymers or copolymers, that exhibit good bonding between the ink receiving layer and the support can be used. The polymeric binder in the subbing layer employed in the invention is preferably a water soluble or water dispersible polymer such as poly(vinyl alcohol), poly(vinyl pyrrolidone), gelatin, a cellulose ether, a poly(oxazoline), a poly(vinylacetamide), partially hydrolyzed poly(vinyl acetate/vinyl alcohol), poly(acrylic acid), poly(acrylamide), poly(alkylene oxide), a sulfonated or phosphated polyester or polystyrene, casein, zein, albumin, chitin, chitosan, dextran, pectin, a collagen derivative, collodian, agar-agar, arrowroot, guar, carrageenan, tragacanth, xanthan, rhamsan and the like, a latex such as poly(styrene-co-butadiene), a polyurethane latex, a polyester latex, or a poly(acrylate), poly(methacrylate), poly(acrylamide) or copolymers thereof

In a preferred embodiment, the subbing layer polymeric binder is a sulfonated polyester dispersion, such as AQ29 ® (Eastman Chemical Co.), gelatin, a polyurethane or poly(vinyl pyrrolidone). The polymeric binder for the subbing layer is preferably used in an amount of from about 1 to about 50 g/m², preferably from about 1 to about 20 g/m².

A borate or borate derivative employed in the subbing layer of the ink jet recording element of the invention may be, for example, borax, sodium tetraborate, boric acid, phenyl boronic acid, or butyl boronic acid. As noted above, the borate or borate derivative is used in an amount of from about 3 to about 50 g/m², preferably from about 3 to about 10 g/m². It is believed that upon coating, the borate or borate derivative in the subbing layer diffuses into the image-receiving layer to cross-link the cross-linkable binder in the image-receiving layer.

Other methods to improve the adhesion of the layer to the support include surface treatment of the support by corona-discharge, plasma-treatment in a variety of atmospheres, UV treatment, which is performed prior to applying the layer to the support.

The recording element of the invention can contain one or more conducting layers such as an antistatic layer to prevent undesirable static discharges during manufacture and printing of the image. This may be added to either side of the element. Antistatic layers conventionally used for color films have been found to be satisfactory, such as those in U.S. Pat. No. 5,147,768, the disclosure of which is hereby incorporated by reference. Preferred antistatic agents include metal oxides, e.g., tin oxide, antimony doped tin oxide and vanadium pentoxide. These antistatic agents are preferably dispersed in a film-forming binder.

The layers described above may be coated by conventional coating means onto a support material commonly used in this art. Coating methods may include, but are not limited to, wound wire rod coating, knife coating, slot coating, slide hopper coating, gravure coating, spin coating, dip coating, skim-pan-air-knife coating, multilayer slide bead, doctor blade coating, gravure coating, reverse-roll coating, curtain coating, multilayer curtain coating and the like. Some of these methods allow for simultaneous coatings of more than one layer, which is preferred from a manufacturing economic perspective if more than one layer or type of layer needs to be applied. Known coating and drying methods are described in further detail in Research Disclosure no. 308119, published December 1989, pages 1007 to 1008. Slide coating is preferred, in which several layers may be simultaneously applied. The support may be stationary, or may be moving so that the coated layer is immediately drawn into drying chambers. After coating, the layers are generally dried by simple evaporation, which may be accelerated by known techniques such as convection heating.

The coating composition may be applied to one or both substrate surfaces through conventional pre-metered or post-metered coating methods listed above. The choice of coating process would be determined from the economics of the operation and in turn, would determine the formulation specifications such as coating solids, coating viscosity, and coating speed. After coating, the inkjet recording element may be subject to calendering or supercalendering to enhance surface smoothness. In a preferred embodiment of the invention, the inkjet recording element is subject to hot soft-nip calendering at a temperature of about 65° C. and a pressure of 14000 kg/m at a speed of from about 0.15 m/s to about 0.3 m/s.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946, 4,239,543 and 4,781,758, the disclosures of which are hereby incorporated by reference.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir.

The following examples are intended to further illustrate, but not to limit, the invention.

### EXAMPLES

Preparation of Porous Polyester Particles PE-1 through PE-10

Precursor polyesters PP-1 through PP-5 were all synthesized by a 2-stage melt polycondensation process. The chemical compositions are listed in Table 1 and the reaction times and final molecular weights are listed in Table 2. The SIP, CHDM, dibutylstannoic acid, zinc acetate, and sodium acetate were combined in a 500 ml 3-neck flask equipped with a stainless steel stirring rod, nitrogen inlet, and an arm leading to a dry ice/acetone condenser with an outlet connected to a controlled vacuum system. A graduated cylinder was connected beneath the condenser with a ground glass joint to collect and measure distillate. The reaction was heated in thermostatted bath containing a metal heating alloy. A steady stream of nitrogen was passed over the reaction mixture for 10 minutes, and was then reduced to a slightly positive flow. The temperature was held at 210-230° C. for 100-250 minutes with stirring at ˜100 RPM until a clear prepolymer resulted and the calculated amount of methanol distillate had been collected in a graduated cylinder. The reaction was removed from the bath and allowed to cool. The FA and IPA were then added and the condenser was filled with ice. The reaction was restarted at 220° C. and within 20 minutes water condensate began to collect. The reaction was held at 220° C. for 130-460 minutes until the viscosity of the melt had increased to the point where the precursor polyester could no longer be effectively stirred and the reaction was terminated.

TABLE 1

| | | | IPA | Mol ratio | CHDM | Zn(OAc)₂ | BuSn(OH)₃ | NaOAc |
|---|---|---|---|---|---|---|---|---|
| | FA (g) | SIP (g) | (g) | FA:SIP:IPA | (g) | (g) | (g) | (g) |
| PP-1 | 19.59 | 50.01 | — | 1:1:0 | 45.57 | 0.02 | 0.02 | 0.69 |
| PP-2 | 21.43 | 27.35 | 15.34 | 2:1:1 | 51.13 | 0.02 | 0.02 | 0.38 |
| PP-3 | 22.49 | 14.35 | 24.14 | 4:1:3 | 53.76 | 0.02 | 0.02 | 0.20 |
| PP-4 | 20.49 | 39.23 | 7.33 | 4:3:1 | 48.80 | 0.02 | 0.20 | 0.54 |
| PP-5 | 48.99 | 125.02 | — | 1:1:0 | 116.42 | 0.06 | 0.04 | 1.73 |

FA is fumaric acid
SIP is dimethyl 5-sulfoisophthalate, sodium salt
IPA is isophthalic acid
CHDM is 1,4-cyclohexanedimethanol, mixture of cis and trans isomers.

TABLE 2

| | Stage 1 | Stage 2 | | |
|---|---|---|---|---|
| | reaction time | reaction time | Mn | Mw |
| PP-1 | 120 min | 130 min | 2,710 | 10,500 |
| PP-2 | 100 min | 420 min | 3,570 | 15,800 |
| PP-3 | 100 min | 460 min | 3,380 | 28,000 |
| PP-4 | 120 min | 180 min | 3,130 | 7,340 |
| PP-5 | 250 min | 200 min | 3,240 | 7,330 |

Precursor polyester PP-6 was synthesized using the same apparatus as used in the preparation of PP-1 through PP-5, and a similar 2-stage procedure. In the first stage, SIP (82.41 g, 0.28 mol), hydroquinone-bis-hydroxyethyl ether (HQBHE) (110.29 g, 0.56 mol), sodium acetate (2.28 g), and titanium isopropoxide (4 drops) were combined in a 500 ml 3-neck round bottom flask and heated for 220-240° C. for 70 minutes at which point a clear, slightly orange prepolymer had formed and the calculated amount of methanol condensate had been collected. The reaction was then cooled and diethyl fumarate (47.90 g, 0.28 mol) was added. The reaction was restarted and was heated at 200° C. for 100 minutes followed by 120 minutes at 220° C. A vacuum was then initiated which ramped from ambient pressure to 20 torr over 2 minutes. The viscosity of the melt began to rapidly increase and the reaction was terminated. (Mn=2940, Mw=5440).

Polyester beads PE-1 through PE-10 were all synthesized by the following procedure. An aqueous phase was prepared by dispersing appropriate precursor polyester in the amount of water noted in Table 3. The water generally had to be heated to 40-60° C. and it required between 20 minutes and 16 hours for the precursor polyester to completely disperse, depending on the amount of SIP monomer in the precursor polyester. The aqueous phase was filtered through cheesecloth and combined in a beaker with an organic phase consisting of the toluene, DVB, hexadecane, and AIBN. The 2 phases were emulsified by any of the three methods listed in Table 3 and transferred to an appropriately sized 3-neck round bottom flask (1 L for PE-1 through 8 or 2 L for PE-9 through 10) fitted with a mechanical stirrer and a reflux condenser with nitrogen inlet. The opaque white microsuspensions were bubble degassed with nitrogen for 10 minutes, then heated overnight at 70° C. for 16 hours. The resulting particle dispersions were cooled to room temperature and the toluene was removed as a water azeotrope via rotary evaporation. The dispersions were washed with 4-6 volumes of water and concentrated to 9-25% solids using a Millipore Amicon ultrafiltration system with a 100K cutoff spiral-wound dialysis cartridge. The exact concentrations of each PE dispersion are listed in Table 4.

TABLE 3

| | | Precursor | | | | | | |
|---|---|---|---|---|---|---|---|---|
| Disper- | Precursor | polyester | Water | DVB¹ | Toluene | AIBN⁵ | Hexadecane | Emulsification |
| sion | polyester | (g) | (ml) | (g) | (g) | (g) | (ml) | method |
| PE-1 | PP-1 | 20.00 | 240 | 20.00 | 40.00 | 0.40 | 4.14 | M² |
| PE-2 | PP-2 | 20.00 | 240 | 20.00 | 40.00 | 0.40 | 4.14 | M² |
| PE-3 | PP-3 | 20.00 | 240 | 20.00 | 40.00 | 0.40 | 4.14 | M² |
| PE-4 | PP-4 | 20.00 | 240 | 20.00 | 40.00 | 0.40 | 4.14 | S³ |
| PE-5 | PP-2 | 20.00 | 240 | 20.00 | 40.00 | 0.40 | 4.14 | S³ |
| PE-6 | PP-3 | 20.00 | 240 | 20.00 | 40.00 | 0.40 | 4.14 | S³ |
| PE-7 | PP-1 | 20.00 | 240 | 20.00 | 40.00 | 0.40 | 4.14 | H⁴ |
| PE-8 | PP-3 | 20.00 | 240 | 20.00 | 40.00 | 0.40 | 4.14 | H⁴ |
| PE-9 | PP-5 | 62.50 | 750 | 68.38 | 125.00 | 1.25 | 12.94 | H⁴ |
| PE-10 | PP-6 | 40.00 | 514 | 40.0 | 80.0 | 0.80 | 2.82 | H⁴ |

¹DVB is divinylbenzene (80% w/w with remainder being ethylstyrene, mixture of m and p isomers.)
²Reaction mixture was passed twice through an M-110T Microfluidizer (sold by Microfluidics).
³Reaction mixture was homogenized for 10 minutes using a Silverson L4R mixer at the highest speed setting and then sonicated using a Vibra Cell probe sonicator (Sonics & Materials Inc) . . .
⁴Reaction mixture was homogenized using a Silverson L4R mixer at the highest speed setting for 10 minutes.
⁵AIBN is 2,2′-azobis(isobutyronitrile)

Determination of Particle Size and Particle Size Distribution

The particle size and particle size distribution of each PE-1 through PE-10 was measured using a laser scattering particle size distribution analyzer, Horiba LA-920, manufactured by Horiba LTD. The results are in Table 4.

TABLE 4

| | | Mode 1 | | | Mode 2 | | |
|---|---|---|---|---|---|---|---|
| PE | | Mean | Propor- | | Mean | Propor- | |
| disper- | Wt % | diameter | tion | CV | diameter | tion | CV |
| sion | solids | (micron) | (%) | (%) | (micron) | (%) | % |
| PE-1 | 13.54 | 0.356 | 100 | 35.2 | — | — | — |
| PE-2 | 12.97 | 0.181 | 5.9 | 15.9 | 0.351 | 94.1 | 36.8 |
| PE-3 | 14.01 | 0.390 | 88.2 | 41.9 | 2.70 | 11.8 | 38.1 |
| PE-4 | 14.37 | 0.470 | 58.6 | 55.3 | 2.24 | 41.4 | 25.2 |
| PE-5 | 12.38 | 0.174 | 45.1 | 21.9 | 0.391 | 54.9 | 31.9 |
| PE-6 | 15.50 | 0.430 | 82.1 | 42.2 | 5.86 | 17.9 | 54.0 |
| PE-7 | 14.00 | 0.897 | 10.6 | 27.1 | 2.62 | 89.4 | 36.0 |
| PE-8 | 16.24 | 0.682 | 7.6 | 36.4 | 3.10 | 92.4 | 37.3 |
| PE-9 | 22.86 | 1.082 | 9.1 | 44.2 | 2.69 | 90.9 | 27.1 |
| PE-10 | 17.60 | 0.434 | 27.6 | 45.3 | 4.46 | 72.4 | 57.5 |

### Example 1

Preparation of Element 1

A coating composition was prepared from 62.78 wt. % of dispersion PE-1, 1.5 wt. % poly(vinyl alcohol), PVA, (Gohsenol® GH-17 from Nippon Gohsei Co.), and 35.72 wt. % water. [The relative proportions of porous polyester particle to PVA are therefore 85/15 by weight]. The coating composition was coated onto a base support comprised of a polyethylene resin coated photographic paper stock, which had been previously subjected to corona discharge treatment, using a calibrated coating knife, and dried to remove substantially all solvent components to form the ink receiving layer. The thickness of the dry ink receiving layer was measured to be about 17±2 μm. The measured surface gloss at 60 degrees was 36 and the ink dry time was measured to be less than 10 seconds.

Preparation of Element 2

A coating composition was prepared from 61.68 wt. % of dispersion PE-2, 2.0 wt. % poly(vinyl alcohol), PVA, (Gohsenol® GH-17 from Nippon Gohsei Co.), and 36.32 wt. % water. [The relative proportions of porous polyester particle to PVA are therefore 80/20 by weight]. The coating composition was coated and dried the same as Element 1. The thickness of the dry ink receiving layer was measured to be about 19±2 μm.

Preparation of Element 3

A coating composition was prepared from 57.10 wt. % of dispersion PE-3, 2.0 wt. % poly(vinyl alcohol), PVA, (Gohsenol® GH-17 from Nippon Gohsei Co.), and 40.90 wt. % water. [The relative proportions of porous polyester particle to PVA are therefore 80/20 by weight]. The coating composition was coated and dried the same as Element 1. The thickness of the dry ink receiving layer was measured to be about 46±2 μm.

Preparation of Element 4

A coating composition was prepared from 59.15 wt. % of dispersion PE-4, 1.5 wt. % poly(vinyl alcohol), PVA, (Gohsenol® GH-17 from Nippon Gohsei Co.), and 39.35 wt. % water. [The relative proportions of porous polyester particle to PVA are therefore 85/15 by weight]. The coating composition was coated and dried the same as Element 1. The thickness of the dry ink receiving layer was measured to be about 18±2 μm.

Preparation of Element 5

A coating composition was prepared from 64.62 wt. % of dispersion PE-5, 2.0 wt. % poly(vinyl alcohol), PVA, (Gohsenol® GH-17 from Nippon Gohsei Co.), and 33.38 wt. % water. [The relative proportions of porous polyester particle to PVA are therefore 80/20 by weight]. The coating composition was coated and dried the same as Element 1. The thickness of the dry ink receiving layer was measured to be about 25±2 μm.

Preparation of Element 6

A coating composition was prepared from 51.61 wt. % of dispersion PE-6, 2.0 wt. % poly(vinyl alcohol), PVA, (Gohsenol® GH-17 from Nippon Gohsei Co.), and 46.39 wt. % water. [The relative proportions of porous polyester particle to PVA are therefore 80/20 by weight]. The coating composition was coated and dried the same as Element 1. The thickness of the dry ink receiving layer was measured to be about 24±2 μm.

Preparation of Control Element C-1

A coating composition was prepared from 60.71 wt. % of dispersion PE-7, 1.5 wt. % poly(vinyl alcohol), PVA, (Gohsenol® GH-17 from Nippon Gohsei Co.), and 37.79 wt. % water. [The relative proportions of porous polyester particle to PVA are therefore 85/15 by weight]. The coating composition was coated and dried the same as Element 1. The thickness of the dry ink receiving layer was measured to be about 26±2 μm.

Preparation of Control Element C-2

A coating composition was prepared from 52.34 wt. % of dispersion PE-8, 1.5 wt. % poly(vinyl alcohol), PVA, (Gohsenol® GH-17 from Nippon Gohsei Co.), and 46.16 wt. % water. [The relative proportions of porous polyester particle to PVA are therefore 85/15 by weight]. The coating composition was coated and dried the same as Element 1. The thickness of the dry ink receiving layer was measured to be about 32±2 μm.

Preparation of Control Element C-3

Control Element C-3 was a commercially available inkjet non-porous receiver paper containing a high amount of gelatin, “Kodak Inkjet Photo Paper”, catalogue No. 1181197 from Eastman Kodak Company.

Preparation of Control Element C-4

Control Element C-4 was a commercially available inkjet porous receiver paper containing a high amount of silica fine particles, “Epson Premium Glossy Photo Paper”, catalogue No. S041286 from Epson.

Printing and Dye Stability Testing

The above elements and control elements of Example 1 were printed using a Lexmark Z51 inkjet printer and a cyan inkjet ink, prepared using a standard formulation with a copper phthalocyanine dye (Clariant Direct Turquoise Blue FRL-SF). The red channel density (cyan) patches at D-max (the highest density setting) were read using an X-Rite ® 820 densitometer. The cyan density is reported in Table 5. The printed elements were then subjected to 4 days exposure to a nitrogen flow containing 5 ppm ozone. The density of each patch was read after the exposure test using an X-Rite ® 820 densitometer. The % dye retention was calculated as the ratio of the density after the exposure test to the density before the exposure test. The results for cyan D-max are reported in Table 5.

Surface Gloss Measurement

The gloss of the top surface of the unprinted ink receiving layer was measured using a BYK Gardner gloss meter at an angle of illumination/reflection of 60°. The results are related to a highly polished black glass with refractive index of 1.567 that has a specular gloss value of 100. The results are reported in Table 5.

Measurement of Ink Dry Time:

A drop (from a 10 microliter capillary tube) of a magenta inkjet ink, prepared using a standard formulation with Dye 6 from U.S. Pat. No. 6,001,161, was placed on each unprinted element and the time that it took for this spot to become dry to the touch was measured as the “ink drying time” as shown in Table 5.

TABLE 5

| | | % dye | | |
|---|---|---|---|---|
| | Cyan | retention | | Ink drying time |
| Element | D-max | cyan D-max | 60° gloss | (seconds) |
| 1 | 1.6 | 91 | 36 | <10 |
| 2 | 1.7 | 94 | 72 | 60 |
| 3 | 1.6 | 96 | 20 | <10 |
| 4 | 1.6 | 85 | 28 | 40 |
| 5 | 1.7 | 96 | 70 | 150 |
| 6 | 1.8 | 99 | 40 | <10 |
| Control C-1 | 1.1 | 96 | 3 | <10 |
| Control C-2 | 1.4 | 93 | 5 | 50 |
| Control C-3 | 1.8 | 99 | 88 | >180 |
| Control C-4 | 2.2 | 27 | 38 | 45 |

The above results show that high surface gloss for the element containing porous polyester particles can only be achieved with the incorporation of porous polyester particles that have a mean diameter of less than 0.5 micrometers, compared to the control elements having only porous polyester particles that have a mean diameter of greater than 0.5 micrometers. The above results also show that, although high surface gloss can be attained with a layer that does not contain porous polyester particles (Control element C-3), rapid ink drying time is not achieved unless the layer contains porous polyester particles. The above results also show that, although high surface gloss and rapid ink drying time can be attained with a porous layer comprising fine-particle silica (Control Element C-4), dye stability towards environmental gases remains poor.

### Example 2

Preparation of Control Element C-5 (Single Layer of Larger Size Particles)

A coating composition was prepared from 53.92 wt. % of dispersion PE-9, 2.18 wt. % poly(vinyl alcohol), PVA, (Gohsenol® GH-17 from Nippon Gohsei Co.), and 43.90 wt. % water. [The relative proportions of porous polyester particle to PVA are therefore 85/15 by weight]. The coating composition was metered to a slot-die coating apparatus and coated onto a base support comprised of a polyethylene resin coated photographic paper stock, which had been previously subjected to corona discharge treatment, moving at a speed of about 2.4 m/min. The coated support immediately entered the drying section of the coating machine to remove substantially all solvent components and form an ink receiving layer. The thickness of the dry ink receiving layer was measured to be about 15±2 μm. The measured surface gloss at 60 degrees was 3 and the ink dry time was measured to be greater than 180 seconds.

Preparation of Element 7

A coating composition (Solution S-9) was prepared the same as in Control Element C-5. A second homogeneous coating composition (Solution S-1) was prepared the same as in Element 1. Both coating compositions were metered to a multiple-slot-die coating apparatus and coated simultaneously, with Solution S-9 being located below (closer to the support than) Solution S-1, onto a base support comprised of a polyethylene resin coated photographic paper stock, which had been previously subjected to corona discharge treatment, moving at a speed of about 2.4 m/min. The coated support immediately entered the drying section of the coating machine to remove substantially all solvent components and form a two-layer image receiving element. The combined thickness of the dry ink receiving layers was measured to be about 19±2 μm. The measured surface gloss at 60 degrees was 23 and the ink dry time was measured to be 100 seconds.

Preparation of Element 8

Coating compositions S-9 and S-1 were prepared the same as Element 7 except that Solution S-1 was 59.08 wt. % of dispersion PE-1, 2.0 wt. % poly(vinyl alcohol), PVA, (Gohsenol® GH-17 from Nippon Gohsei Co.), and 38.92 wt. % water. [The relative proportions of porous polyester particle to PVA are therefore 80/20 by weight]. The coating compositions were coated and dried the same as Element 7. The combined thickness of the dry ink receiving layers was measured to be about 20±2 μm. The measured surface gloss and the ink dry time are reported in Table 6.

Preparation of Element 9

A coating composition (Solution S-9) was prepared the same as in Control Element C-5. A second homogeneous coating composition (Solution S-2) was prepared the same as in Element 2 except that Solution S-2 was prepared from 65.54 wt. % of dispersion PE-2, 1.5 wt. % poly(vinyl alcohol), PVA, (Gohsenol® GH-17 from Nippon Gohsei Co.), and 32.96 wt. % water. [The relative proportions of porous polyester particle to PVA are therefore 85/15 by weight]. The coating compositions were coated and dried the same as Element 7, with Solution S-9 being located below (closer to the support than) Solution S-2. The thickness of the dry lower layer was measured to be about 12±2 μm and the thickness of the dry upper layer was measured to be about 9±2 μm. The measured surface gloss and the ink dry time are reported in Table 6.

Preparation of Element 10

Coating compositions S-9 and S-2 were prepared, coated and dried the same as Element 9 except that the thickness of the layers were different. The combined thickness of the dry ink receiving layers was measured to be about 12±2 μm. The measured surface gloss and the ink dry time are reported in Table 6.

Preparation of Element 11

A coating composition (Solution S-9) was prepared the same as in Control Element C-5. A second homogeneous coating composition (Solution S-10) was prepared from 48.30 wt. % of dispersion PE-10, 1.5 wt. % poly(vinyl alcohol), PVA, (Gohsenol® GH-17 from Nippon Gohsei Co.), and 50.20 wt. % water. [The relative proportions of porous polyester particle to PVA are therefore 85/15 by weight]. The coating compositions were coated and dried the same as Element 7, with Solution S-9 being located below (closer to the support than) Solution S-10. The thickness of the dry lower layer was measured to be about 20±2 μm and the thickness of the dry upper layer was measured to be about 5±2 μm. The measured surface gloss and the ink dry time are reported in Table 6.

The above elements of Example 2 were printed using a Lexmark Z51 inkjet printer and a cyan inkjet ink, prepared using a standard formulation with a copper phthalocyanine dye (Clariant Direct Turquoise Blue FRL-SF). The red channel density (cyan) patches at D-max (the highest density setting) are reported in Table 6.

TABLE 6

| | | | Ink drying |
|---|---|---|---|
| | Cyan | | time |
| Element | D-max | 60° gloss | (seconds) |
| 7 | 1.7 | 23 | 100 |
| 8 | 1.6 | 30 | 120 |
| 9 | 1.7 | 65 | 120 |
| 10 | 1.7 | 48 | 180 |
| 11 | 1.6 | 10 | 20 |
| Control C-5 | 1.1 | 3 | >180 |

The above results show that high surface gloss and improved print density for the element can be achieved with a multi-layer ink receiving layer structure, particularly when the upper layer contains porous polyester particles that have a mean diameter of less than 0.5 micrometers.

The invention has been described in detail with particular reference to certain preferred embodiments thereof, but it will be understood that variations and modifications can be effected within the spirit and scope of the invention.

What is claimed is:

1. Porous polyester particles comprising porous polyester particles having a mean diameter of less than 0.5 micrometers.

2. The particles of claim 1 wherein said particles have a mean diameter range between 0.1 and less than 0.5 micrometers.

3. The particles of claim 1 wherein said particles have a mean diameter range between 0.2 and 0.3 micrometers.

4. The particles of claim 1 wherein the precursor polyester comprises at least one member of the group consisting of maleic, fumaric, itaconic, phenylenediacrylic, citraconic and mesaconic acid.

5. The particles of claim 4 wherein said precursor polyester further comprises sulfonated monomer.

6. The particles of claim 4 wherein said precursor polyester has an acid number of at least 10.

7. The particles of claim 4 wherein said precursor polyester has a molecular weight of 1,000 to 30,000 gm/mole.

8. The particles of claim 1 wherein said particles have an ionic group equivalent weight of between 40 and 2000 grams per mole of ionic unit.

9. The particles of claim 8 wherein said ionic group comprises sulfonate functionality.

10. The particles of claim 1 wherein said particles are dry.

11. The particles of claim 1 wherein said particles are in an aqueous dispersion.

12. The particles of claim 1 wherein said particles are surfactant stabilized.

13. The particles of claim 1 wherein said particles are stabilized by a colloidal inorganic.

14. The particles of claim 1 wherein said particles are stabilized by a protective colloid.

15. The particles of claim 1 wherein said porous particles are a component of a system including at least one particle size system distribution mode of a mean particle diameter greater than 0.5 micrometers.

16. The particles of claim 1 wherein said porous particles have a standard deviation in the mean diameter the value of which is between 0.3 times the mean particle diameter and 3 times the mean particle diameter.

17. The particles of claim 15 wherein said system includes at least one particle size distribution mode of a mean particle diameter between 1 and 10 micrometers.

18. The particles of claim 15 wherein said system includes at least one particle size distribution mode of a mean particle diameter between 1 and 3 micrometers.

19. The particles of claim 1 wherein said porous polyester particles further comprise the copolymerization product of at least one ethylenically unsaturated monomer.

20. The particles of claim 1 wherein said porous polyester particles further comprise the copolymerization product of at least one ethylenically unsaturated monomer selected from the group consisting of styrene, divinylbenzene, divinyl adipate, and cyclohexanedimethanol divinyl ether.

21. An inkjet recording element comprising a support having thereon an ink receiving layer capable of accepting an inkjet image comprising at least one layer comprising porous polyester particles comprising porous polyester particles having a mean diameter of less than 0.5 micrometers.

22. The inkjet recording element of claim 21 wherein said at least one layer further comprises a polymeric binder.

23. The inkjet recording element of claim 22 wherein said particles comprise between 50 and 95% by weight of said at least one layer.

24. The inkjet recording element of claim 22 wherein said particles comprise between 75 and 90% by weight of said at least one layer.

25. The inkjet recording element of claim 22 wherein said polymeric binder comprises poly(vinyl alcohol).

26. The inkjet recording element of claim 22 wherein said polymeric binder comprises sulfonated polyester.

27. The inkjet recording element of claim 22 wherein said polymeric binder comprises gelatin.

28. The inkjet recording element of claim 22 wherein said polymeric binder comprises water dispersible polyurethane.

29. The inkjet recording element of claim 21 wherein said porous particles are a component of a system including at least one particle size system distribution mode of a mean particle diameter greater than 0.5 micrometers.

30. The inkjet recording element of claim 21 wherein said porous particles have a standard deviation in the mean diameter the value of which is between 0.3 times the mean particle diameter and 3 times the mean particle diameter.

31. The inkjet recording element of claim 29 wherein said system includes at least one particle size distribution mode of a mean particle diameter between 1 and 10 micrometers.

32. The inkjet recording element of claim 29 wherein said system includes at least one particle size distribution mode of a mean particle diameter between 1 and 3 micrometers.

33. The inkjet recording element of claim 21 wherein said porous polyester particles further comprise the copolymerization product of at least one ethylenically unsaturated monomer.

34. The inkjet recording element of claim 21 wherein said porous polyester particles further comprise the copolymerization product of at least one ethylenically unsaturated monomer selected from the group consisting of styrene, divinylbenzene, divinyl adipate and cyclohexanedimethanol divinyl ether.

35. The inkjet recording element of claim 21 wherein the precursor polyester comprises at least one member the group consisting of maleic, fumaric, itaconic, phenylenediacrylic, citraconic and mesaconic acid.

36. The inkjet recording element of claim 35 wherein said precursor polyester further comprises sulfonated monomer.

37. The inkjet recording element of claim 35 wherein said precursor polyester has an acid number of at least 10.

38. The inkjet recording element of claim 35 wherein said precursor polyester has a molecular weight of 1,000 to 30,000.

39. The inkjet recording element of claim 21 wherein said element further comprises at least one layer comprising porous polyester particles having a mean diameter of greater than 0.5 micrometers.

40. The inkjet recording element of claim 39 wherein said at least one layer comprising porous polyester particles having a mean diameter of greater than 0.5 micrometers is located below said layer comprising porous particles having a mean diameter of less than 0.5 micrometers.

41. The inkjet recording element of claim 40 wherein said at least one layer comprising porous polyester particles having a mean diameter of greater than 0.5 micrometers further comprises porous polyester particles having a mean diameter of less than 0.5 micrometers.

42. The inkjet recording element of claim 40 wherein said at least one layer comprising porous polyester particles comprising porous polyester particles having a mean diameter of less than 0.5 micrometers further comprises porous polyester particles having a mean diameter of greater than 0.5 micrometers.

43. The inkjet recording element of claim 40 wherein said at least one layer comprising porous polyester particles comprising porous polyester particles having a mean diameter of less than 0.5 micrometers further comprises porous polyester particles having a mean diameter of greater than 0.5 micrometers and wherein said at least one layer comprising porous polyester particles comprising porous polyester particles having a mean diameter of greater than 0.5 micrometers further comprises porous polyester particles having a mean diameter of less than 0.5 micrometers.

44. The inkjet recording element of claim 40 wherein said layer comprising porous particles having a mean diameter of less than 0.5 micrometers has a thickness of between 1 and 20 micrometers.

45. The inkjet recording element of claim 40 wherein said layer comprising said at least one layer comprising porous polyester particles having a mean diameter of greater than 0.5 micrometers has a thickness of between 5 and 50 micrometers.

46. The ink receiving layers of claim 40 having a combined thickness of between 6 and 65 micrometers.

47. The inkjet recording element of claim 21 wherein said element further comprises absorbed copper phthalocyanine dye and said ink receiving element has a dye density loss in ozone of less then 2% per day per ppm ozone.

48. The inkjet recording element of claim 21 wherein said element is a single layer and has a surface gloss of greater than or equal to 20 at 60 degrees.

49. The element of claim 21 wherein said support is paper or a coated paper.

50. The element of claim 21 wherein said support is selected from the group consisting of poly(ethylene terephthalate), a polyolefin-coated and a polyolefin-laminated paper.

51. The element of claim 21 wherein said support is transparent.

52. A method of forming an inkjet print comprising providing an inkjet recording element comprising porous polyester particles comprising porous polyester particles having a mean diameter of less than 0.5 micrometers and printing on said inkjet recording element utilizing an inkjet printer.

53. An inkjet recording element comprising a support having thereon an ink receiving layer capable of accepting an inkjet image comprising at least one layer comprising porous polyester particles comprising porous polyester particles having a mean diameter of less than 0.5 micrometers, and at least one layer comprising porous polyester particles having a mean diameter of greater than 0.5 micrometers which is located below said layer comprising porous particles having a mean diameter of less than 0.5 micrometers.

54. An inkjet recording element comprising a support having thereon an ink receiving layer capable of accepting an inkjet image comprising at least one layer comprising porous polyester particles comprising porous polyester particles having a mean diameter of less than 0.5 micrometers, and at least one layer comprising porous polyester particles having a mean diameter of greater than 0.5 micrometers in combination with porous polyester particles having a mean diameter of less than 0.5 micrometers which is located below said layer comprising porous particles having a mean diameter of less than 0.5 micrometers.
